(19) United States
(12) Patent Application Publication
(10) Pub. No.: US 2007/0007789 A1
(43) Pub. Date: Jan. 11, 2007

(54) Tailgate recliner

(76) Inventors: Alan S. Bowden, New Brockton, AL (US); Tanya Bowden, New Brockton, AL (US)

Correspondence Address: Raymond M. Galasso;Galasso & Associates LP, P.O. Box 26503, Austin, TX, 78755-0503, US

(21) Appl. No.: 11/175,510

(22) Filed: Jul. 6, 2005

(51) Int. Cl. B60N 2/04

(52) U.S. Cl. 296/64

(57) ABSTRACT

A tailgate recliner chair to be secured to the tailgate of a pickup truck. The chair includes a padded seat portion, a padded backrest which can be reclined by a user, a leg support and foot support which can be elevated by a user. The recliner chair is secured to the tailgate via a strap wrapped around the tailgate and secured to a base under the seat portion.

### FIELD OF THE INVENTION

The present invention relates to a seat for the use on the tailgate of a vehicle, more specifically but not by way of limitation to a reclining chair for attachment to the tailgate of a pickup truck.

### BACKGROUND

Thousands of people all over the country user their trucks and the tailgates on the trucks to supply convenience and functionality for a variety of events and purposes. One mainstay in using the tailgate on a truck is to participate in tailgating activities or outings. Whether it is a racing event, a football game, a baseball game, or simply a weekend camping, the tailgate is perfect to use as an additional surface for sitting. Unfortunately, while the tailgate is often used as a seat, it lacks any sort of comfort or ergonomic amenity. This is due, in part to the design and primary function of a trucks tailgate.

Therefore, there is a need for a comfortable, ergonomic portable seat that is easily attached a removed from the tailgate of a truck, without disrupting the original design and functionality of the tailgate.

### BRIEF DESCRIPTION OF THE DRAWING FIGURES

A more complete understanding of the present invention may be had by reference to the following Detailed Description and appended claims when taken in conjunction with the accompanying Drawings wherein:

FIG. 1 illustrates a front perspective view of a tailgate recliner chair secured to the tailgate of a truck in accordance with principles of the present invention;

FIG. 2 illustrates a top front perspective view of a tailgate recliner chair in accordance with the principles of the present invention;

FIG. 3 illustrates a partial side elevational view of in accordance with the principles of the present invention;

FIG. 4 illustrates a partial front perspective view of another embodiment of the foot rest of a tailgate recliner in accordance with the principles of the present invention;

FIG. 5 illustrates a front perspective view of another alternative embodiment of the present invention; and

FIG. 6 illustrates a front perspective view of yet another alternative embodiment of the present invention.

### DETAILED DESCRIPTION

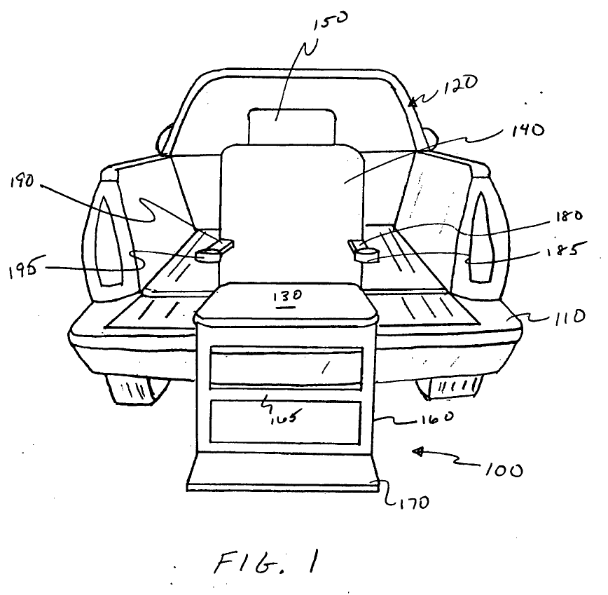

Referring now to the drawings wherein the various elements depicted are not necessarily drawn to scale, and in particular to FIG. 1, there is illustrated a preferred embodiment of a tailgate recliner 100 secured to the rear tailgate 110 of a pickup truck 120. Tailgate recliner 100 includes a seat 130, backrest 140, headrest 150, leg support 160, foot rest 170, and armrests 180 and 190. In this preferred embodiment leg support 160 is generally an “H” frame support with cross support 165 not only providing support for a users legs when sitting upon tailgate recliner 100, but also provides structure support and provides stability. Footrest 170 extends from the bottom portion of leg support 160. Armrests 180 and 190 include cup or beverage holders 185 and 195 at the ends thereof. Cup holders 185 and 195 are configured to facilitate receiving and holding many shapes and types of cups, cans, bottles and other beverage containers.

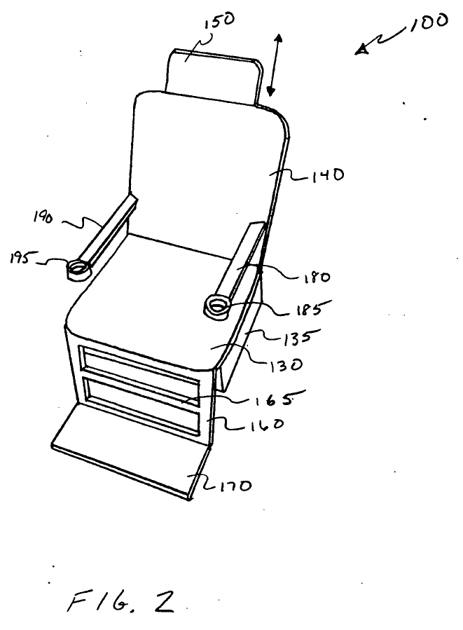

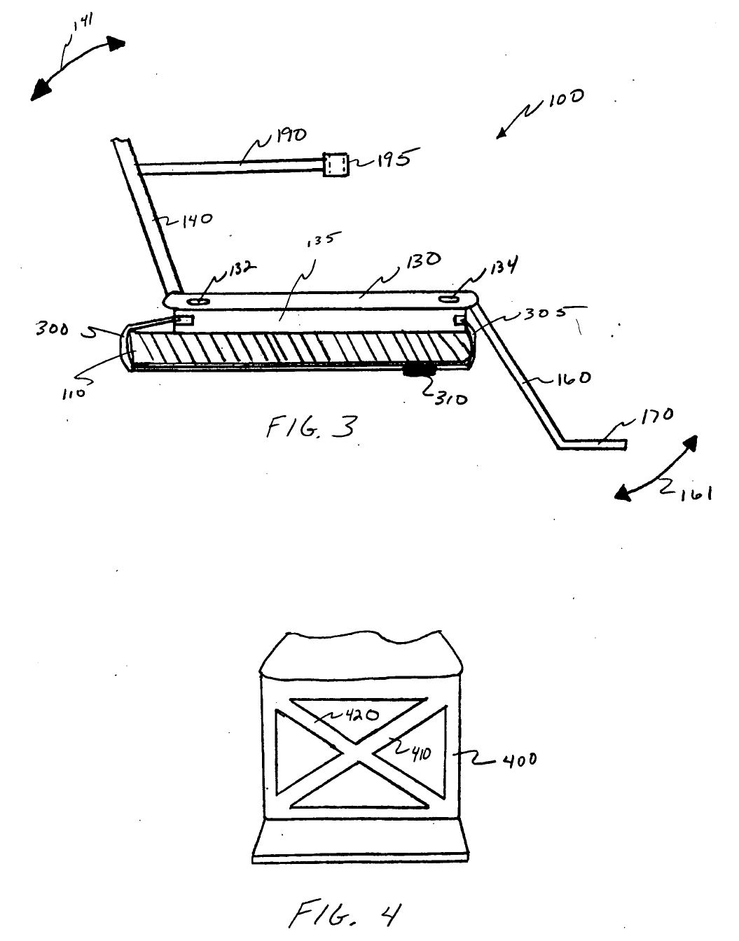

As illustrated, tailgate recliner 100 is removabley attached to the open tailgate 110 of a pickup truck 120. A user would then sit upon seat 130 while putting their feet upon foot rest 170. As the user sits back into tailgate recliner 100, their back engages backrest 140 and their head engages headrest 150. Their arms can also be placed upon armrests 180 and 190. Thus, tailgate recliner 100 provides a more ergonomic environment for the user sitting on a tailgate, and also provides much increased comfort. Tailgate recliner 100 is also configured to allow for the headrest to be adjustable (see FIG. 2) and is also further configured to allow backrest 140 to recline as well configure to allow the raising of leg support 160 and foot rest 170 (see FIG. 3). When foot rest 170 is in a lowered position, foot rest 170 can also act as a step for a user to use to enter the rear of the truck.

As can be appreciated, any of the seat 130, back rest 140, head rest 150, arm rest 180 and 190, and leg support 160 could be covered with padded material to further facilitate a more comfortable tailgate recliner 100. It is further contemplated that material used to cover any of the seat 130, back rest 140, head rest 150, arm rest 180 and 190, and leg support 160 be of a durable, weather resistant material.

Referring not to FIG. 2, there is illustrated a top right perspective view of tailgate recliner 100. As described herein above, tailgate recliner 100 includes seat 130, backrest 140, headrest 150, leg support 160 with foot rest 170 extending from the bottom end of leg support 160, armrests 180 and 190, and cup or beverage holders 185 and 195 at the ends of armrests 180 and 190. Further illustrated is a base 135 attachable to the bottom of seat 130. Base 135 is positioned between seat 130 and the tailgate of the truck. Base 135 acts as an interface or buffer between the bottom of seat 130 and the tailgate of the truck. Base 135 is of a material, such as but not limited to dense foam, to facilitate protection to both tailgate recliner 100 and the tailgate of the truck by preventing either from damaging the other. Base 135 also provides additional comfort to the user by adding more cushioning under the user when sitting on seat 130 of tailgate recliner 100. As indicated by the arrow, headrest 150 is adjustable up and down to facilitate the height of a user.

Referring now to FIG. 3, there is illustrated a partial side view of the tailgate recliner 100 secured to tailgate 110. As described herein above, tailgate recliner 100 includes seat 130, backrest 140, leg support 160 with foot rest 170 extending from the bottom end of leg support 160, armrest 190 and cup or beverage holder 195 at the end of armrest 190. Base 135 is attached to the bottom of seat 130. Straps 300 and 305 are connected to base 135, with strap 300 extending for the rear and strap 305 extending from the front of base 135. Straps 300 and 305 are typical types of straps and are adjustable in length to accommodate various sizes of tailgates 110. As illustrated, strap 300 is connected to strap 305 with a fastener or buckle 310. Although only on strap set, straps 300 and 305 is illustrated, it is contemplated that any number of strap sets could be utilized, depending on the size of tailgate recliner 100. Although in the embodiment illustrated in FIG. 3 straps and a buckle are used to secure tailgate recliner 100 to the open tailgate 110 of a pickup truck, it is contemplated to be within the scope of this invention that various attachment mechanism could be utilized, such as a “C” shaped clamp which slides onto tailgate 110, a non skid mat could be placed between base 135 and tailgate 110, to inhibit the slipping and moving of tailgate recliner 100 thereon, and straps connected together by hook-loop fastener.

As is further illustrated in FIG. 3, backrest 140 of tailgate recliner 100 is adjustable from a generally upright position to a reclined positioned, and various positions in between, as indicated by arrow 141. The adjustment of the position of backrest 140 is controlled by lever 132. The position of leg support 160 and footrest 170 is also adjustable between various positions as indicated by arrow 161. The adjustment of the position of leg support 160 and footrest 170 is controlled by lever 134.

Referring now to FIG. 4, there is illustrated an alternative embodiment for a leg support for recliner chair 100. Leg support 400 is generally an “X” frame, with cross supports 410 and 420 generally forming an “X” shape. This particular shaped frame for leg support 400 provides both support for a users legs when sitting upon tailgate recliner 100 as well as provides support and stability.

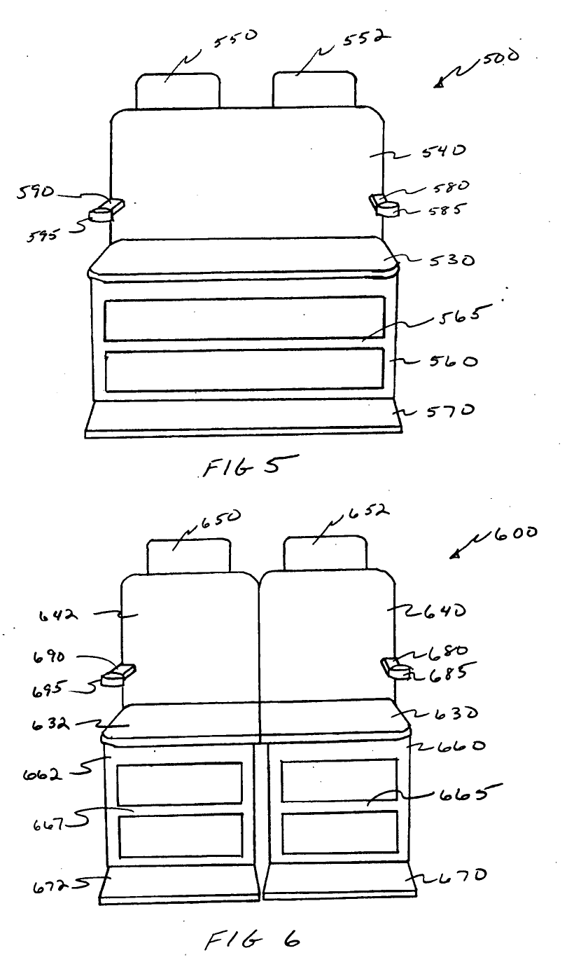

Referring now to FIG. 5, there is illustrated another embodiment of a tailgate recliner 500 designed for two user. As similarly described herein above with reference to FIGS. 1 and 2, tailgate recliner 500 includes a seat 530, backrest 540, headrests 550 and 552, leg support 560, foot rest 570, and armrests 580 and 590. In this preferred embodiment leg support 560 is generally an “H” frame support with cross support 565 not only providing support for a users legs when sitting upon tailgate recliner 500, but also provides structure support and provides stability. Footrest 570 extends from the bottom portion of leg support 560. Armrests 580 and 590 include cup or beverage holders 585 and 595 at the ends thereof. Cup holders 585 and 595 are configured to facilitate receiving and holding many shapes and types of cups, cans, bottles and other beverage containers. Backrest 540 of tailgate recliner 500 is designed to recline and leg support 560 is designed to be elevated, both accomplished in a similar fashion as described in reference to FIG. 3. As illustrated, seat 530, backrest 540, leg support 560 and footrest 570 are of such dimension to easily facilitated two users thereon.

Referring now to FIG. 6, there is illustrated another embodiment of a tailgate recliner 600 designed for two user. As illustrated tailgate recliner 600 includes a seats 630 and 632, backrests 540 and 542, headrests 650 and 652, leg supports 660 and 662, foot rests 670 and 672, and armrests 680 and 690. In this preferred embodiment leg supports 660 and 662 are generally an “H” frame support with cross supports 665 and 667 not only providing support for users legs when sitting upon tailgate recliner 600, but also provides structure support and provides stability. Footrests 670 and 672 extend from the bottom portions of leg support 660 and 662. Armrests 680 and 690 include cup or beverage holders 685 and 695 at the ends thereof. Cup holders 685 and 695 are configured to facilitate receiving and holding many shapes and types of cups, cans, bottles and other beverage containers. Each of backrest 640 and 642 of tailgate recliner 600 are designed to recline independently from each other, and leg supports 660 and 662 are designed to each be elevated independently from each other, all being accomplished in a similar fashion as described in reference to FIG. 3. As illustrated, seats 630 and 632, backrests 640 and 642, leg supports 660 and 662, and footrests 670 and 672 are of such dimension to easily facilitated two users on tailgate recliner 600.

It is further contemplated to be within the scope of this invention, that each of the embodiments described herein are designed such that they can be easily folded up to facilitate storage and transportation. Additionally, each of the embodiments could be modified to accept various accessories, such as an umbrella.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A seat comprising:
a seat portion configured to be attached to a tailgate of a vehicle;
a first backrest extending from a first end of said seat portion, said backrest positionable between at least a first position and a second position;
a leg support extending from a second end of said seat portion;
a foot support extending from said leg support; and
a first armrest extending from said seat portion.

2. The seat device as recited in claim 1, and further including a base connected to said seat portion and positionable between the seat and the tailgate, said base including a strap for securing the base to said tailgate.

3. The seat as recited in claim 1, and further including a second armrest extending from said seat portion opposite said first armrest.

4. The seat as recited in claim 3, wherein at least one of said first armrest and said second armrest includes a cup holder.

5. The seat as recited in claim 1, wherein said leg support is positionable between at least a first position and a second position.

6. The seat as recited in claim 1, wherein said leg support includes an “H” shaped frame.

7. The seat as recited in claim 1, wherein said leg support includes an “X” shaped frame.

8. The seat as recited in claim 1, and further including a second backrest extending from the first end of the seat portion, said second backrest being adjacent to said first back rest, said second backrest being positionable between at least a first position and a second position.

9. A tailgate reclining seating device, comprising:
a seat portion, said seat portion securable to a tailgate of a vehicle;
a backrest extending from a first end of said seat portion, said backrest configure to be reclined between various positions;
a leg support extending from a second end of said seat portion;
a foot support extending from said leg support; and
a first armrest extending from said seat portion.

10. The seating device as recited in claim 9, and further including a base connected to said seat portion and positionable between the seat and the tailgate.

11. The seating device as recited in claim 9, and further including a second armrest extending from said seat portion.

12. The seating device as recited in claim 11, wherein at least one of said first armrest and said second armrest include a cup holder.

13. The seating device as recited in claim 9. where said leg support is positionable between at least a first position and a second position.

14. The seating device as recited in claim 9, wherein said leg support includes an “H” shaped frame.

15. The seating device as recited in claim 9, wherein said leg support includes an “X” shaped frame.

16. The seating device as recited in claim 9, and further including a second backrest extending from the first end of the seat portion, said second backrest being adjacent to said first back rest, said second backrest being positionable between at least a first position and a second position.

17. A tailgate seat system, comprising:
a padded seat portion, said seat portion securable to a tailgate of a vehicle;
a padded backrest extending from a first end of said seat portion, said backrest configure to be reclined in various positions;
a leg support extending from a second end of said seat portion;
a foot support extending from said leg support; and
a first armrest extending from said seat portion, said first armrest including a cupholder.

18. The tailgate seat system as recited in claim 17, and further including a base connected to said seat portion and positionable between the seat and the tailgate, said base including a strap for securing the base to said tailgate.

19. The tailgate seat system as recited in claim 18, wherein said leg support is positionable between at least a first position and a second position.

20. The tailgate seat system as recited in claim 19, and further including a second backrest extending from the first end of the seat portion, said second backrest being adjacent to said first back rest, said second backrest being positionable between a least a first position and a second position.
